(19) United States
(12) Patent Application Publication
(10) Pub. No.: US 2023/0324237 A1
(43) Pub. Date: Oct. 12, 2023

(54) TARGET ANALYZER, TARGET ANALYSIS METHOD, AND TARGET ANALYSIS SYSTEM

(71) Applicant: NEC Corporation, Minato-ku, Tokyo (JP)

(72) Inventors: Kenji Miyazaki, Tokyo (JP); Munehisa Kamio, Tokyo (JP); Satoshi Mukai, Tokyo (JP)

(73) Assignee: NEC Corporation, Minato-ku, Tokyo (JP)

(21) Appl. No.: 18/022,105

(22) PCT Filed: Aug. 20, 2020
(86) PCT No.: PCT/JP2020/031532

§ 371 Date: Feb. 17, 2023

(51) Int. Cl. G01L 1/18; G01N 19/00

(52) U.S. Cl. CPC G01L 1/18; G01N 19/00

(57) ABSTRACT

An example aspect of the invention, a target analyzer including at least one processor configured to:
acquire reference signal information including at least two reference data measured using a MSS device including a MSS in which a binding substance capable of binding to a target is disposed and a control MSS and a reference solution,
acquire identification information of the device that has measured the reference signal information,
associate with the reference signal information measured using the device and the identification information of the MSS device,
acquire measurement signal information including at least two measurement data measured using the device and a sample solution,
acquire identification information of the device that has measured the measurement signal information,
associate with the measurement signal information and the identification information, and
analyze a target in the sample solution from the reference signal information and the measurement signal information associated with the identification information.

### TECHNICAL FIELD

The present invention relates to a target analyzer, a target analysis method, and a target analysis system.

### BACKGROUND ART

In a wide variety of fields such as food, medicine, and the like, detection of targets is important, and various methods have been proposed. In Patent Literature 1, a membrane-type surface stress-sensor (hereinafter, also referred to as “MSS”) is described as a target analyzing instrument.

### CITATION LIST

### Patent Literature

Patent Literature 1: WO2011/148774

### SUMMARY

### Technical Problem

When a target in a sample solution is analyzed by a MSS, first, prior to measuring a signal using the sample solution, a reference solution such as a buffer solution is loaded onto a MSS, and then a measurement apparatus of the MSS is used to apply a voltage to the MSS to obtain a reference signal. The reference solution is then removed from the MSS and the sample solution is loaded onto the MSS. Then, the analyzer is again used to apply a voltage to the MSS to obtain a signal (measurement signal) of the sample solution. Then, the analyzer analyzes whether a target is present in a sample solution using the obtained reference signal and the measurement signal. For this reason, when analyzing a target in a sample solution using the MSS, the MSS needs to be attached to and detached from the analyzer at least twice at the time of obtaining a reference signal and at the time of obtaining a measurement signal.

In a laboratory or the like, a plurality of sample solutions are analyzed in parallel. Therefore, the sample solutions are analyzed by using one analyzer to which a plurality of MSSs can be attached to measure or by using a plurality of analyzers. In this case, when the MSS is attached to an analyzer different from the analyzer that has measured the reference signal or to a different attachment portion of the same analyzer to measure the measurement signal, the analyzer performs analysis using an incorrect reference signal, which may result in an incorrect analysis.

With the foregoing in mind, an example object of the invention is to provide a target analyzer, a target analysis method, and a target analysis system that can suppress generation of an erroneous analysis result even if the MSS is attached to an analyzer different from the analyzer that has measured the reference signal or to a different attachment portion of the same analyzer to measure the measurement signal.

### Solution to Problem

In order to achieve the above object, a target analyzer according to an example aspect of the invention (hereinafter, also referred to as a “first target analyzer”) includes:
a reference signal acquisition unit;
a first identification information acquisition unit;
a first association unit;
a measurement signal acquisition unit;
a second identification information acquisition unit;
a second association unit; and
an analysis unit, wherein
the reference signal acquisition unit acquires reference signal information, wherein
the reference signal information includes at least two measurement data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two measurement data include: first reference data measured using the membrane-type surface stress-sensor in which a binding substance capable of binding to a target is disposed; and second reference data measured using the control membrane-type surface stress-sensor;
the first identification information acquisition unit acquires identification information of the membrane-type surface stress-sensor device that has measured the reference signal information,
the first association unit associates the reference signal information measured using the membrane-type surface stress-sensor device with the identification information of the membrane-type surface stress-sensor device,
the measurement signal acquisition unit acquires measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
the second identification information acquisition unit acquires identification information of the membrane-type surface stress-sensor device that has measured the measurement signal information,
the second association unit associates the measurement signal information with the identification information, and
the analysis unit analyzes a target in the sample solution from the reference signal information and the measurement signal information associated with the identification information.

A target analyzer according to an example aspect of the invention (hereinafter, also referred to as a “second target analyzer”) includes:
a first signal acquisition unit;
a second signal acquisition unit; and
an analysis unit, wherein
the first signal acquisition unit acquires reference signal information associated with identification information of a membrane-type surface stress-sensor device,
the reference signal information includes at least two reference data measured using the membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
the second signal acquisition unit acquires measurement signal information associated with identification information of the membrane-type surface stress-sensor device, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor, and
the analysis unit analyzes a target in the sample solution from the reference signal information and the measurement signal information associated with the identification information.

A target analysis method according to an example aspect of the invention (hereinafter, also referred to as a “first analysis method”) includes:
reference signal acquiring;
first identification information acquiring;
first associating;
measurement signal acquiring;
second identification information acquiring;
second associating; and
analyzing, wherein
in the reference signal acquiring, reference signal information is acquired, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the first identification information acquiring, identification information of the membrane-type surface stress-sensor device that has measured the reference signal information is acquired,
in the first associating, the reference signal information measured using the membrane-type surface stress-sensor device is associated with the identification information of the membrane-type surface stress-sensor device,
in the measurement signal acquiring, measurement signal information is acquired, wherein
the measurement signal information includes at least two measurement data measured using the membrane-type surface stress-sensor device and a sample solution, and
the at least two measurement data include: first measurement data measured using a membrane-type surface stress-sensor in which a binding substance capable of binding to a target is disposed; and second measurement data measured using a control membrane-type surface stress-sensor;
in the second identification information acquiring, identification information of the membrane-type surface stress-sensor device that has measured the measurement signal information is acquired,
in the second associating, the measurement signal information is associated with the identification information, and
in the analyzing, a target in the sample solution is analyzed from the reference signal information and the measurement signal information associated with the identification information.

A target analysis method according to an example aspect of the invention (hereinafter, also referred to as a “second analysis method”) includes:
first signal acquiring;
second signal acquiring; and
analyzing, wherein
in the first signal acquiring, reference signal information associated with identification information of a membrane-type surface stress-sensor device is acquired,
the reference signal information includes at least two reference data measured using the membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the second signal acquiring, measurement signal information associated with identification information of the membrane-type surface stress-sensor device is acquired, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor, and
in the analyzing, a target in the sample solution is analyzed from the reference signal information and the measurement signal information associated with the identification information.

A program according to an example aspect of the invention (hereinafter, also referred to as a “first program”) for causing a computer to execute:
a reference signal acquisition procedure;
a first identification information acquisition procedure;
a first association procedure;
a measurement signal acquisition procedure;
a second identification information acquisition procedure;
a second association procedure; and
an analysis procedure, wherein
in the reference signal acquisition procedure, reference signal information is acquired, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the first identification information acquisition procedure, identification information of the membrane-type surface stress-sensor device that has measured the reference signal information is acquired,
in the first association procedure, the reference signal information measured using the membrane-type surface stress-sensor device is associated with the identification information of the membrane-type surface stress-sensor device,
in the measurement signal acquisition procedure, measurement signal information is acquired, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
in the second identification information acquisition procedure, identification information of the membrane-type surface stress-sensor device that has measured the measurement signal information is acquired,
in the second association procedure, the measurement signal information is associated with the identification information, and
in the analysis procedure, a target in the sample solution is analyzed from the reference signal information and the measurement signal information associated with the identification information.

A program according to an example aspect of the invention (hereinafter, also referred to as a “second program”) for causing a computer to execute:
a first signal acquisition procedure;
a second signal acquisition procedure; and
an analysis procedure, wherein
in the first signal acquisition procedure, reference signal information associated with identification information of a membrane-type surface stress-sensor device is acquired,
the reference signal information includes at least two reference data measured using the membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the second signal acquisition procedure, measurement signal information associated with identification information of the membrane-type surface stress-sensor device is acquired, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor, and
in the analysis procedure, a target in the sample solution is analyzed from the reference signal information and the measurement signal information associated with the identification information.

A target analysis system according to an example aspect of the invention (hereinafter, also referred to as an “analysis system”) includes:
a terminal; and
a server, the terminal and the server being connectable via a communication network outside the system, wherein
the terminal or the server includes:
a reference signal acquisition unit;
a first identification information acquisition unit;
a first association unit;
a measurement signal acquisition unit;
a second identification information acquisition unit;
a second association unit; and
an analysis unit, wherein
the reference signal acquisition unit acquires reference signal information, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
the first identification information acquisition unit acquires identification information of the membrane-type surface stress-sensor device that has measured the reference signal information,
the first association unit associates the reference signal information measured using the membrane-type surface stress-sensor device with the identification information of the membrane-type surface stress-sensor device,
the measurement signal acquisition unit acquires measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
the second identification information acquisition unit acquires identification information of the membrane-type surface stress-sensor device that has measured the measurement signal information,
the second association unit associates the measurement signal information with the identification information, and
the analysis unit analyzes a target in the sample solution from the reference signal information and the measurement signal information associated with the identification information.

### Advantageous Effects of Invention

According to an example aspect of the invention, even if the MSS is attached to an analyzer different from the analyzer that has measured the reference signal or to a different attachment portion of the same analyzer to measure the measurement signal, generation of an erroneous analysis result can be suppressed.

### BRIEF DESCRIPTION OF DRAWINGS

FIG. 1 is a schematic perspective view illustrating an example of a first analysis system including a first analyzer according to a first example embodiment.

FIG. 2 is a block diagram illustrating an example of an analyzer in the first analysis system according to the first example embodiment.

FIG. 3A, FIG. 3B, and FIG. 3C are schematic diagrams illustrating an example of a MSS device (MSS cartridge) analyzed by the first analyzer of first example embodiment, FIG. 3A is a perspective view of the cartridge, FIG. 3B is a schematic diagram showing the arrangement of MSSs attached to the cartridge, and FIG. 3C is an enlarged view of the area surrounded by a dashed-dotted line in FIG. 3B.

FIG. 4A and FIG. 4B are flowcharts illustrating a configuration of an example of the first analysis method and the program according to the first example embodiment.

FIG. 5 is a schematic diagram illustrating an example of processing of acquired data according to the first example embodiment.

FIG. 6 is a block diagram illustrating an example of a configuration of an analysis system including a measurement apparatus, an analyzer, and a data server according to the second example embodiment.

FIG. 7 is a block diagram illustrating an example of a hardware configuration of a control unit of the measurement apparatus according to the second example embodiment.

FIG. 8 is a block diagram illustrating an example of a hardware configuration of the analyzer according to the second example embodiment.

FIG. 9 is a flowchart illustrating processing or a measurement method and a learning method of the measurement apparatus, the analyzer, and the data server in the analysis system according to the second example embodiment.

### EXAMPLE EMBODIMENTS

In an example aspect of the invention, the “membrane-type surface-stress sensor” is also referred to as a MSS in the following description. In a so-called MSS, a membrane having a binding ability to a target is supported by a support having a piezoresistive element. When the target binds to the membrane, the membrane suffers stress due to the binding, and the membrane deforms due to the generation of distortion or the like (generation of distortion). A stress is generated in the piezoresistive element of the support that supports the membrane depending on the amount of deformation of the membrane, and the resistance value of the piezoresistive element changes in proportion to the stress. Therefore, by applying a voltage to the MSS and measuring an electric signal accompanying a change in resistance value, the MSS can indirectly analyze the presence or absence of the target bonded to the membrane qualitatively. Furthermore, by applying a voltage to the MSS and measuring an electric signal accompanying a change in resistance value, the MSS can quantitatively analyze the amount of the target bonded to the membrane. In an example aspect of the invention, by using a binding substance that binds to a target, specifically, by immobilizing the binding substance to the membrane, the target is bonded to the MSS through the binding substance. Therefore, other than immobilizing the binding substance to the membrane, the configuration of the MSS is not particularly limited, and existing configurations and configurations in future that exhibit similar functions can be utilized.

In an example aspect of the invention, the “target” is not particularly limited and may be any substance as long as it is capable of contacting the binding substance in a liquid, i.e., in a liquid phase, for example. Examples of the target include microorganisms including bacteria such as anthrax, Escherichia coli, Salmonella, and the like; viruses such as influenza virus, and the like; and allergens. Examples of the allergen include grains such as wheat, and the like; eggs; meat; fish; shellfish; vegetables; fruits; milk; beans such as peanuts, and the like; and pollens such as cedar pollen, cypress pollen, and the like. The type of the target is not particularly limited, and examples thereof include polymer compounds such as a protein, a sugar chain, a nucleic acid, a polymer, and the like; and low-molecular compounds.

In an example aspect of the invention, the “binding substance” may be a molecule capable of binding to a target, that is, a binding molecule. Examples of the binding substance include an antibody and an aptamer. When the target is a receptor or a ligand thereof, the binding substance may be a ligand or a receptor, respectively. When a receptor for a ligand is used as the binding substance, the receptor may be a fusion protein with a Fc region of an immunoglobulin, i.e., a receptor-Fc fusion protein, preferably a fusion protein with a Fc region of an IgG protein, i.e., a receptor-IgG Fc. The Fc fusion protein can be prepared, for example, by linking the C-terminal amino acid of the receptor directly or via a linker to the N-terminal amino acid of a CL region or a CH1 region of an immunoglobulin.

In an example aspect of the invention, the “antibody” can also be referred to as a soluble form of an immunoglobulin having binding ability to a target. Examples of the type of the antibody include IgA, IgD, IgE, IgG, and IgM. Examples of IgA include IgA1 and IgA2. Examples of IgG include IgG1, IgG2, IgG3, and IgG4. The antibody may be an antigen binding-fragment thereof, i.e., a partial peptide of an antibody having binding ability to the target. The antigen binding-fragment is, for example, a polypeptide including a part of the antibody, more specifically, a polypeptide including a binding region or a variable region of the antibody. Examples of the antigen-binding fragment include Fab, Fab′, F(ab′)2, Fv fragments, rIgG (half IgG) fragments, single-chain antibody (scFv), dual variable domain antibody (DVD-Ig™) diabody, triabody, tetrabody, tandab, flexibody which is a combination of scFv and diabody, tandem scFv (e.g., BiTE®, produced by Micromet), DART® (produced by MacroGenics), Fcab™ or mAb²™ (produced by F-star), Fc engineering antibody (produced by Xencor), and DuoBody® (produced by Genmab). As the antibody, a known antibody having binding ability to a target or an antigen-binding fragment thereof may be used, or a new antibody or an antigen-binding fragment thereof obtained by immunizing a target with an animal or the like may be used. The antibody may be a monoclonal antibody or a polyclonal antibody. The antibody may be a blood-derived fraction, such as serum, plasma, or the like, containing an antibody capable of binding to a target.

In an example aspect of the invention, the “aptamer” is a nucleic acid molecule having a binding ability to a target. The aptamer can also be, for example, a nucleic acid molecule that specifically binds to a target. Examples of the constituent unit of the aptamer include nucleotide residues and non-nucleotide residues. Examples of the nucleotide residue include deoxyribonucleotide residues and ribonucleotide residues, wherein the nucleotide residues may be modified or unmodified, for example. Examples of the aptamer include DNA aptamers consisting of deoxyribonucleotide residues, RNA aptamers consisting of ribonucleotide residues, aptamers including both deoxyribonucleotide residues and ribonucleotide residues, and aptamers including modified nucleotide residues. The length of the aptamer is not particularly limited and is, for example, from 10 to 200 bases. For example, existing aptamers may be used as the aptamer to the target, or aptamers newly obtained by a SELEX method or the like may be used depending on the target, for example.

In an example aspect of the invention, “binding to” or “capable of binding” may mean that a binding substance actually binds to a binding target, or may mean that a binding substance binds to a binding target in a simulation using a molecular docking method or the like, and is preferably the former. The bond between the binding substance and the binding target can be detected using, for example, a method of analyzing protein-protein interactions, and can be detected using, for example, a method of using an antibody-antigen reaction such as co-immunoprecipitation, pull-down assay, ELISA method, or flow cytometry. As a specific example, the bond between the binding substance and the binding target can be detected, for example, by bringing a cell expressing the binding target with a labeled binding substance and then detecting the label in the cell.

The binding substance is preferably an aptamer or an antibody.

In an example aspect of the invention, the “reference solution” is, for example, a solution capable of acquiring a signal of the background of the MSS, and specifically, a solution containing no target. The reference solution can be appropriately determined according to, for example, the type of a specimen contained in the sample solution to be described below or a diluted solution of the specimen, and specific examples thereof include water and a buffer solution. The reference solution may include a surfactant such as Tween®, for example.

In an example aspect of the invention, the “sample solution” is not particularly limited as long as it is a liquid. When a collected sample is a liquid, the collected sample may be used as a liquid sample as it is or after diluting, suspending, dispersing, or the like with a liquid solvent. When a collected sample is a solid, for example, a liquid sample may be prepared by dissolving, suspending, dispersing, or the like with a liquid solvent. In addition, when a collected sample is a gas, for example, a liquid sample may be prepared by concentrating an aerosol in the gas or may be prepared by further dissolving, suspending, dispersing, or the like with a liquid solvent. The type of the liquid solvent is not particularly limited, and is, for example, a solvent which hardly affects the binding between a binding substance and a target, and specific examples of the liquid solvent include water and a buffer. Examples of the collected sample include food, blood, urine, saliva, body fluid, soil, drainage, tap water, pond, river, and air.

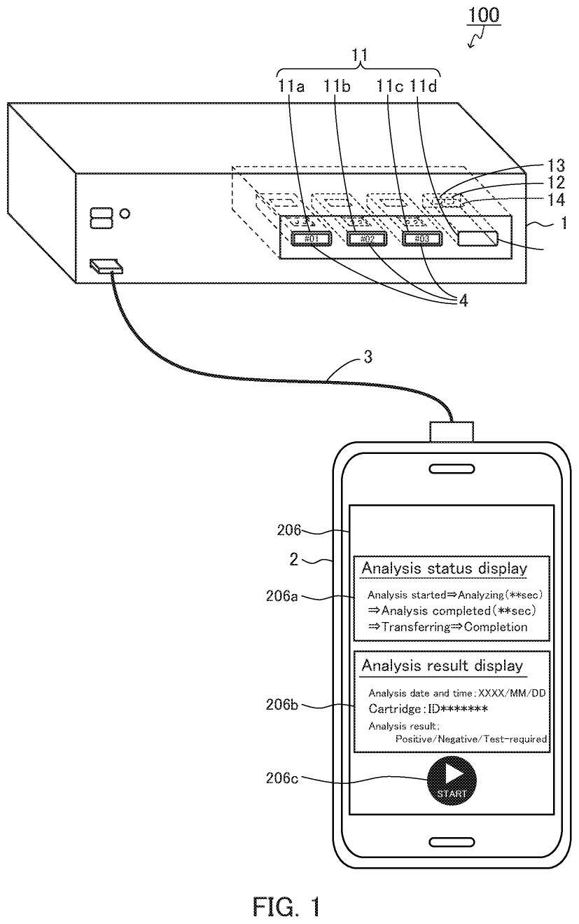

Example embodiments of the invention will be described with reference to FIGS. 1 to 9. Note here that the present invention is not limited and restricted by the following example embodiments by any means. In FIGS. 1 to 9, identical parts are indicated with identical reference signs. In addition, the descriptions of the respective example embodiments can be referred to each other unless otherwise specified. Furthermore, the configurations of the example embodiments can be combined unless otherwise specified.

### First Example Embodiment

The present example embodiment is an example of a first analysis system including a measurement apparatus and a first analyzer of an example aspect of the invention. FIG. 1 is a schematic perspective view illustrating an example of a first analysis system 100 of the present example embodiment. As shown in FIG. 1, the first analysis system 100 includes a measurement apparatus 1 and an analyzer 2. The measurement apparatus 1 and the analyzer 2 are connected to each other via a communication cable 3 so as to be able to communicate bidirectionally. The measurement apparatus 1 further includes four attachment portions 11 (11a to 11d), a voltage application unit 12, a measurement unit 13, and an identification information acquisition unit 14. In FIG. 1, MSS devices (MSS cartridges) 4 outside the first analysis system 100 are attached to three attachment portions 11a to 11c of the four attachment portions 11. The analyzer 2 includes a touch panel 206. The touch panel 206 displays an analysis status 206a of a sample solution, an analysis result 206b, and a button 206c capable of controlling starting and stopping of analysis by the analysis system 100.

In the measurement apparatus 1, a MSS cartridge 4 can be detachably attached to the attachment portion 11. The attachment portion 11 is configured such that, for example, when the MSS cartridge 4 is attached, electrodes 43a and 44a of the MSS cartridge 4 to be described below are brought into contact with the voltage application unit 12 and the measurement unit 13. The shape of the attachment portion 11 can be appropriately determined according to the shape of the MSS cartridge 4.

While the measurement apparatus 1 includes four attachment portions 11a to 11d, the number of the attachment portions 11 is not limited to four, and the measurement apparatus 1 include any number of one or more attachment portions.

The voltage application unit 12 is configured to be capable of applying a voltage to the MSS cartridge 4, and specifically, the voltage application unit 12 is configured to be capable of applying a voltage to the electrodes 43a and 44a of the MSS cartridge 4 attached to the attachment portion 11. The voltage application unit 12 is configured such that, when the MSS cartridge 4 is fitted to the attachment portion 11, the terminals of the voltage application unit 12 can be brought into contact with the electrodes 43a and 44a of the MSS cartridge 4 on the side of the attachment portion 11 to be in contact with the MSS cartridge 4. The voltage application unit 12 may be a voltage generator or a power source such as a voltage and current generator.

The measurement unit 13 can measure the voltage of the MSS cartridge 4, and specifically, the measurement unit 13 can measure the change in the voltage caused by a change in the stresses of the piezoresistive elements 43e and 44e of the MSS membranes 43d and 44d in the MSS cartridge 4. The measurement unit 13 can measure, for example, a change in a resistance value caused by a change in stresses of the piezoresistive elements 43e and 44e as an electronic signal. For example, a resistance meter or the like can be used as the measurement unit 13. The measurement unit 13 is electrically connected to the 43a and 44a of the MSS cartridge 4.

The identification information acquisition unit 14 can acquire identification information of the MSS cartridge 4, and specifically, can read identification information from an identifier 42 of the MSS cartridge 4. The identification information acquisition unit 14 is disposed at a position where the identifier 42 of the MSS cartridge 4 can be read when the cartridge 4 is attached to the attachment portion 11. The identification information acquisition unit 14 can appropriately be determined according to the type of the identifier 42 of the MSS cartridge 4. As a specific example, when the identifier 42 is a printed identifier such as a bar code, a QR code®, or the like with identification information, a reader provided with an optical imaging device such as a camera can be used as the identification information acquisition unit 14. When the identifier 42 is a radio frequency identification (RFID) of an IC tag or the like that stores identification information, for example, a RFID reader or the like can be used as the identification information acquisition unit 14. When the identifier 42 is magnetic data such as a magnetic tape with identification information, for example, a magnetic reading device can be used as the identification information acquisition unit 14. When the identifier 42 is an external storage medium such as a USB with identification information, for example, a reading device of an external storage medium can be used as the identification information acquisition unit 14.

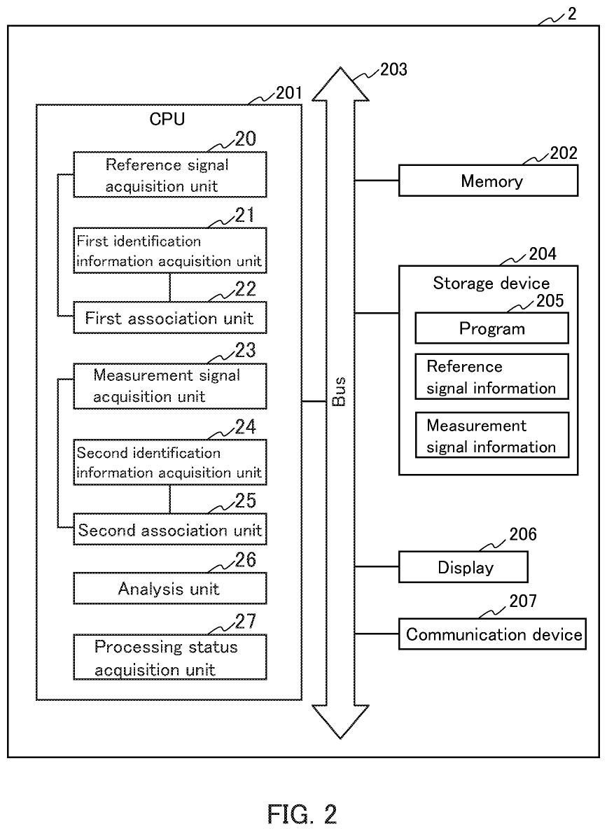

FIG. 2 shows a block diagram of a hardware configuration of the analyzer 2. The analyzer 2 includes, for example, a CPU (central processor) 201, a memory 202, a bus 203, a storage device 204, a display (touch panel) 206, a communication device 207, and the like. The components of the analyzer 2 are connected via the bus 203 by respective interfaces (I/F).

The CPU 201 operates in cooperation with other configurations by, for example, a controller (a system controller, an I/O controller, or the like), and is responsible for controlling the entire analyzer 2. In the analyzer 2, for example, the program 205 of an example aspect of the invention and other programs are executed by the CPU 201, and various kinds of information such as reference signal information, measurement signal information, and the like are read and written. Specifically, for example, the CPU 201 functions as a reference signal acquisition unit 20, a first identification information acquisition unit 21, a first association unit 22, a measurement signal acquisition unit 23, a second identification information acquisition unit 24, a second association unit 25, an analysis unit 26, and a processing status acquisition unit 27. While the analyzer 2 includes the CPU as an arithmetic unit, the analyzer 2 may include other arithmetic units such as graphics processing unit (GPU), accelerated processing unit (APU), and the like, or the analyzer 2 may include a combination of the CPU and these.

The memory 202 includes, for example, a main memory. The main memory is also referred to as a main storage device. When the CPU 201 performs processing, for example, the memory 202 reads various operation programs such as the program 205 of an example aspect of the invention stored in the storage device 204 (auxiliary storage device) to be described below. The CPU 201 reads the data from the memory 202, decodes the data, and executes the program. The main memory is, for example, a random access memory (RAM). The memory 202 further includes, for example, a ROM (read-only memory).

The bus 203 can also be connected to an external device, for example. Examples of the external device include an external storage device (such as an external database) and a printer. The analyzer 2 can be connected to the communication cable 3 by the communication device 207 connected to the bus, and can be connected to the measurement apparatus 1 via the communication cable 3. The analyzer 2 may be connected to a communication line network outside the first analysis system 100 by, for example, a communication device 207 connected to the bus, and may be connectable to the external device via the communication line network.

The storage device 204 is also referred to as a so-called auxiliary storage device with respect to the main memory (main memory device), for example. As described above, the storage device 204 stores operation programs including the program 205 of an example aspect of the invention and various kinds of information. The storage device 204 includes a storage medium and a drive for reading from and writing to the storage medium, for example. The storage medium is not particularly limited, and may be, for example, a built-in type or an external type, and examples thereof include HDs (hard disks), FDs (floppy® disks), CD-ROMs, CD-Rs, CD-RWs, MOs, DVDs, flash memories, and memory cards. The drive is not particularly limited. The storage device 204 may be a hard disk drive (HDD) in which the storage medium and the drive are integrated, for example.

The analyzer 2 includes a touch panel type display 206 as an input device and an output device (display unit). As described above, the display 206 can display an analysis status 206a of the sample solution, an analysis result 206b, and a button 206c. While the input device and the output device of the analyzer 2 are integrally configured in the present example embodiment, the input device and the output device may be separately configured. Examples of the input device include pointing devices such as a track pad, a mouse, and the like; keyboards; imaging units such as a camera, a scanner, and the like; card readers such as an IC card reader, a magnetic card reader, and the like; and voice input units such as a microphone, and the like. Further, examples of the output device include display devices such as a light emitting diode (LED) display, a liquid crystal display, and the like.

The communication cable 3 may be any cable capable of bidirectional communication. While the communication cable 3 is configured to be able to communicate bidirectionally in the present example embodiment, the communication cable 3 may be able to perform one-way communication. In this case, the communication cable 3 is configured to be able to transmit various kinds of information acquired by the measurement apparatus 1 to the analyzer 2. While the measurement apparatus 1 and the analyzer 2 are communicably connected via the communication cable 3 in the present example embodiment, the measurement apparatus 1 and the analyzer 2 may be communicably connected via a wireless line or a communication line network outside the first analysis system 100.

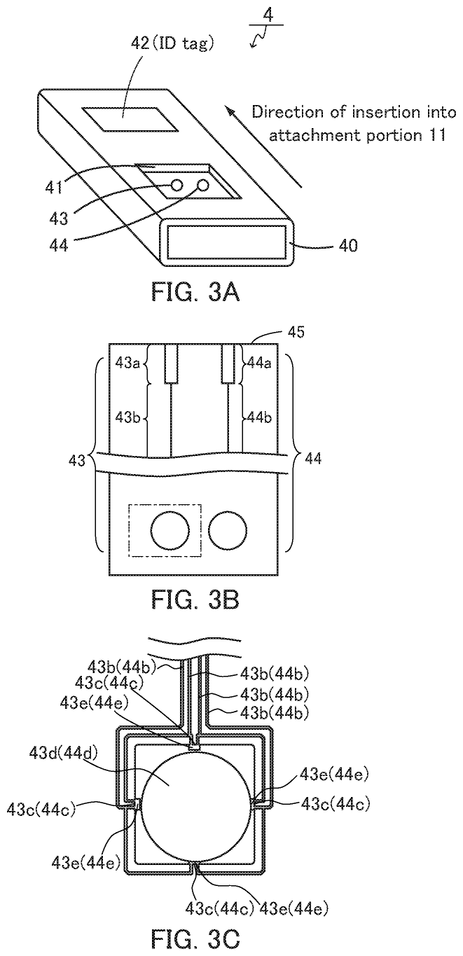

FIG. 3A, FIG. 3B, and FIG. 3C are schematic diagrams illustrating an example of the MSS cartridge 4. In FIG. 3, FIG. 3A is a perspective view of the cartridge, FIG. 3B is a schematic diagram illustrating the arrangement of the MSSs attached to the cartridge, and FIG. 3 C is an enlarged view of the area surrounded by a dashed-dotted line in FIG. 3B. As shown in FIG. 3A in FIG. 3, the MSS cartridge 4 includes a housing 40, an identifier 42, and two MSSs 43 and 44. The housing 40 has an opening 41 serving as a sample placement portion for being loaded the sample solution. The two MSSs 43 and 44 are housed in the housing 40 such that MSS membranes 43d and 44d of the MSSs 43 and 44 are disposed in the opening 41 of the housing 40. The sample placement portion is an area surrounded by the opening 41 and the MSS cartridge 4. The identifier 42 (ID tag) for storing the identification information of the MSS cartridge 4 is disposed at the end of the housing 40 in the inserting direction to the attachment portion 11. The MSS 43 is a MSS in which a binding molecule for a target is disposed, as will be described below. On the other hand, as will be described below, a binding molecule for a target is not disposed in the MSS 44, and it can also be referred to as a control MSS.

The two MSSs 43 and 44 are disposed on a sensor substrate 45. That is, the sensor substrate 45 includes the MSSs 43 and 44. The MSSs 43 and 44 includes electrodes 43a and 44a, wirings 43b and 44b, support region 43c and 44c, membranes (MSS membranes) 43d and 44d, and piezoresistive elements 43e and 44e, respectively. The MSS membrane 43d of the MSS 43 includes a binding molecule, that is, a binding molecule is immobilized on the MSS membrane 43d. On the other hand, the MSS membrane 44d of the MSS 44 does not have a binding molecule. Note that the MSS 44 may include a binding molecule that does not bind to a target, i.e., a control binding molecule. The binding molecule that does not bind to a target is, for example, a binding molecule of the same kind as the binding molecule disposed on the MSS membrane 43d of the MSS 43.

The sensor substrate 45 is a substrate for disposing the electrodes 43a and 44a, the wirings 43b and 44b, the support regions 43c and 44c, the MSS membranes 43d and 44d, and the piezoresistive elements 43e and 44e. Specifically, the sensor substrate 45 includes a plurality of support regions 43c and 44c for supporting the MSS membranes 43d and 44d, and the support regions 43c and 44c include the piezoresistive elements 43e and 44e. The sensor substrate 45 supports the MSS membranes 43d and 44d by the support regions 43c and 44c, respectively. Binding molecules are immobilized on one surface or both surfaces of the MSS membrane 43d facing each other, and the MSS membrane 43d is supported by the sensor substrate 45 on the side surface, for example. On the other hand, no binding molecule is immobilized on one surface or both surfaces of the MSS membrane 44d facing each other, and the MSS membrane 44d is supported by the sensor substrate 45, for example. The sensor substrate 45 preferably partially supports, for example, the MSS membrane 43d, 44d, and specifically preferably partially supports the side surface of the MSS membrane 43d, 44d. In the MSS membrane 43d, 44d, the number of portions (support portions) supported by the support region 43c, 44c of the sensor substrate 45 is not particularly limited, and is, for example, four points. Note that this is an example, and the number of support portions is not limited in any way, and any number of support portions may be provided.

While two MSSs are disposed on the sensor substrate 45 in the present example embodiment, the number of MSSs disposed on the sensor substrate 45 may be two or more, and can be determined according to, for example, the number of targets to be analyzed. In the present example embodiment, the MSSs may be disposed in arrays on the sensor substrate 45.

In the sensor substrate 45, the support region 43c, 44c is, for example, a silicon membrane, and the p-type region (p-type Si) can function as the piezoresistive element 43e, 44e by doping any region of the silicon membrane into a p-type region. The support region 43c, 44c includes, for example, piezoresistive element 43e, 44e at or near positions where the MSS membrane 43d, 44d is supported. The entire sensor substrate 45 may be made of silicon, or only the support region 43c, 44c of the sensor substrate 45 may be a silicon membrane, and materials other than the support region 43c, 44c including the piezoresistive element 43e, 44e are not particularly limited, for example. As a material of the sensor substrate 45, for example, plastic, glass, or the like can be used.

The sensor substrate 45 includes, for example, a circuit for applying a voltage. The circuit includes the electrode 43a, 44a and the wiring 43b, 44b. For example, the circuit may be a Wheatstone bridge circuit including a plurality of piezoresistive elements 43e, 44e in the support region 43c, 44c when the support region 43c, 44c supports the MSS membrane 43d, 44d at a plurality of points and includes piezoresistive elements 43e, 44e at and near positions where the MSS membrane 43d, 44d is supported. The MSS cartridge 4 of the present example embodiment can measure an electric signal associated with a change in the resistance value of the piezoresistive element 43e, 44e by applying a voltage to the Wheatstone bridge circuit.

The electrode 43a, 44a is a connecting portion for measuring a change in stress on the MSS membrane 43d, 44d through a change in the resistance value of the piezoresistive element 43e, 44e by applying a voltage in the measurement apparatus 1. Examples of the material of the electrode 43a, 44a include conductive materials, and specific examples thereof include metals such as gold, copper, and aluminum.

The wiring 43b, 44b is a wiring that electrically connects the electrode 43a, 44a to the piezoresistive element 43e, 44e. The wiring 43b, 44b connects the electrode 43a, 44a to the piezoresistive element 43e, 44e. Examples of the material of the wiring 43b, 44b include conductive molecules, and specific examples thereof include metals such as gold, copper, and aluminum. As described above, in the present example embodiment, the electrode 43a, 44a and the wiring 43b, 44b form a Wheatstone bridge circuit.

The support region 43c, 44c is a region that supports the MSS membrane 43d, 44d. In the present example embodiment, the support region 43c, 44c supports the side surface of the MSS membrane 43d, 44d at four points, and the piezoresistive element 43e, 44e is formed on the support region 43c, 44c. However, the number of the support regions 43c, 44c is not particularly limited as long as the MSS membrane 43d, 44d can be supported.

As described above, the MSS membrane 43d, 44d is not particularly limited as long as it is deformed by binding of the binding molecule, which causes stress of the piezoresistive element 43e, 44e. As described above, among the MSS membrane 43d, 44d, the binding molecule is disposed on the MSS membrane 43d, and the binding of the binding molecule to the target deforms the MSS membrane 43d. On the other hand, among the MSS membrane 43d and 44d, the binding molecule is not disposed on the MSS membranes 44d, and the MSS membranes 44d corresponds to a so-called control MSS membrane. The MSS membrane 43d, 44d is, for example, a thin membrane, and the thickness thereof and the area of the respective surfaces are not particularly limited, and are, for example, the same as those of a MSS membrane used in a commercially available MSS. The planar shape of MSS membrane 43d, 44d is, for example, a circular shape, and specifically, is, for example, a regular circle. The material of the MSS membrane 43d, 44d is not particularly limited, and is, for example, a silicone membrane, and is specifically, for example, n-type Si (100).

The piezoresistive element 43e, 44e is an element capable of detecting deformation of the MSS membrane 43d, 44d, that is, an element capable of detecting stresses on the MSS membrane 43d, 44d. In the MSS 43 and 44, while a piezoresistive element 43e, 44e is used as an element capable of detecting the deformation of the MSS membrane 43d, 44d, another element capable of detecting the deformation of 43d, 44d of the MSS membrane may be used. While the piezoresistive elements 43e, 44e are formed in all of the four support regions 43c, 44c in the present example embodiment, the piezoresistive elements 43e, 44e may be formed in some of the four support regions 43c, 44c.

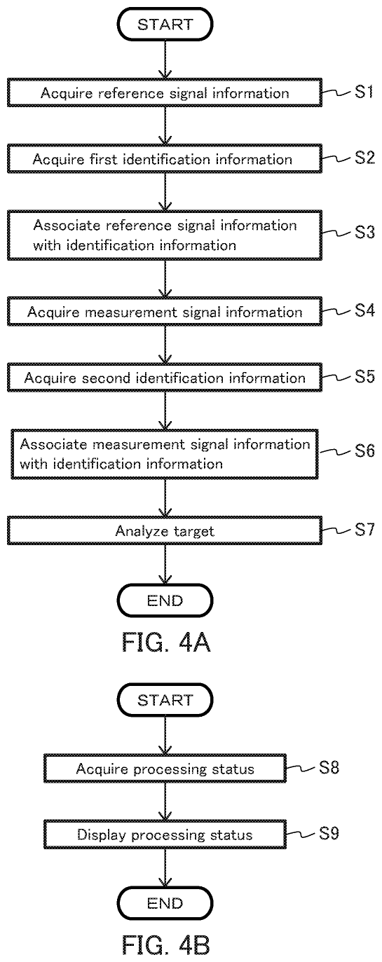

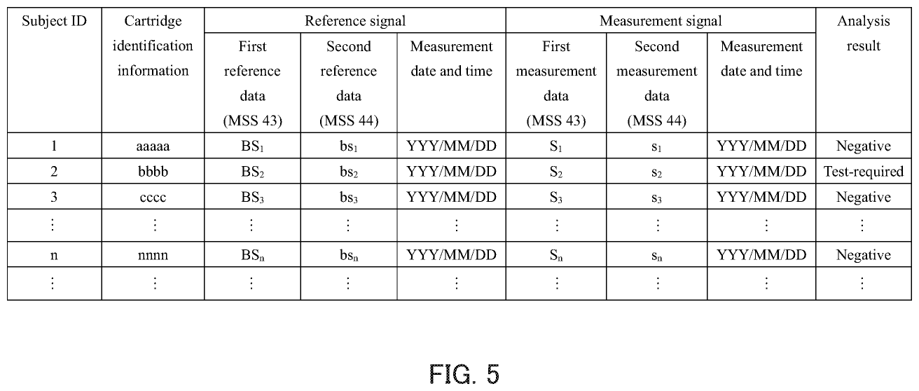

Next, an example of the processing in the analysis system 100 of the present example embodiment will be described with reference to the flowchart of FIG. 4 (FIG. 4A and FIG. 4B) and the processing example of the acquired data of FIG. 5, taking as an example a case where the processing is performed by the analyzer 2 on the basis of various kinds of information acquired by the measurement apparatus 1. While the case where the sample solution derived from the n-th subject is used will be described as an example, the processing can be performed in the same manner also in the case of using the sample solution of another subject and another sample solution.

First, prior to measuring the reference signal information, the user of the analysis system 100 loads the reference solution for the n-th subject into the MSS 43, 44 of the MSS cartridge 4. Next, the user attaches the MSS cartridge 4 loaded with the reference solution to the attachment portion 11 of the measurement apparatus 1. Then, the user inputs subject information such as subject ID, subject ticket ID, subject passport ID, and subject facial information, and then touches a button 206c on the touch panel 206 of the analyzer 2, whereby the measurement apparatus 1 is controlled and the measurement of the electric signal of the MSS cartridge 4 is started. Specifically, the voltage application unit 12 of the measurement apparatus 1 applies a voltage to the electrode 43a, 44a of the MSS cartridge 4, and the measurement unit 13 acquires the electric signal of the MSS 43, 44 of the MSS cartridge 4 over time via the electrode 43a, 44a. Thus, the measurement apparatus 1 acquires the first reference data BSₙ and the second reference data bsₙ. The first reference data BSₙ and the second reference data bsₙ are, for example, data in which a measurement time is associated with a measurement value of an electric signal at each time. The measurement time by the measurement apparatus 1 may be a time specified by the user, or may be a time in which the change amount in the electric signal over time becomes equal to or less than a certain value and a period satisfying a certain value becomes a certain period. Then, the measurement apparatus 1 associates the reference data with the information of the MSS that has measured the data. In addition, the identification information acquisition unit 14 of the measurement apparatus 1 acquires the identification information of the MSS cartridge 4 stored in the identifier 42 of the MSS cartridge 4 before and after or at the same time the electric signal is acquired.

Next, processing by the analyzer 2 is started. First, the reference signal acquisition unit 20 acquires reference signal information (S1). Specifically, the reference signal acquisition unit 20 acquires the reference signal information acquired by the measurement apparatus 1 via the communication cable 3. The reference signal acquisition unit 20 may acquire the reference signal information from the measurement apparatus 1 in parallel with the acquisition of the reference signal information by the measurement apparatus 1. That is, the reference signal acquisition unit 20 may acquire the reference signal information from the measurement apparatus 1 over time, or collectively acquire the reference signal information after acquiring the reference signal information of the measurement apparatus 1. The reference signal acquisition unit 20 may acquire the measurement date and time of the reference signal information together with the reference signal information.

As described above, the MSS cartridge 4 includes the MSS 43 in which the binding molecule is disposed and the MSS 44 in which the binding molecule is not disposed. Thus, as shown in FIG. 5, the reference signal information acquired by the reference signal acquisition unit 20 includes the first reference data BSₙ acquired by the MSS 43 and the second reference data bsₙ of the MSS 44 which is a control MSS.

Next, the first identification information acquisition unit 21 acquires identification information of the MSS cartridge 4 that has acquired the reference signal information (S2). Specifically, the first identification information acquisition unit 21 acquires the identification information of the MSS cartridge 4 acquired by the measurement apparatus 1 via the communication cable 3.

While step S2 is performed after step S1 in the present example embodiment, the order of step S1 and step S2 is not particularly limited, and step S2 may be performed before or after step S1, or step S1 and step S2 may be performed in parallel.

Next, the first association unit 22 associates the reference signal information with the identification information of the MSS cartridge 4 (S3). Specifically, as shown in FIG. 5, the first association unit 22 associates the first reference data BSₙ included in the reference signal information and the second reference data bsₙ with the identification information (nnnn) of the MSS cartridge 4. As shown in FIG. 5, the first association unit 22 may associate the subject information, such as the subject ID (n), input by the user with the identification information (nnnn) of the MSS cartridge 4. As shown in FIG. 5, the first association unit 22 may associate the measurement date and time of the reference signal information with the identification information (nnnn) of the MSS cartridge 4. The first association unit 22 stores, for example, information associated with the storage device 204.

Next, in order to perform measurement using a sample solution of a subject, the user detaches the MSS cartridge 4 from the attachment portion 11 of the measurement apparatus 1. Then, the user removes the reference solution and loads the sample solution of the n-th subject into the MSS 43, 44 of the MSS cartridge 4. While the reference solution is removed in the present example embodiment, a sufficient amount of the sample solution may be added to the MSS cartridge 4 loaded with the reference solution. Next, the user attaches the MSS cartridge 4 loaded with the sample solution to the attachment portion 11 of the measurement apparatus 1. Then, when the user touches a button 206c on the touch panel 206 of the analyzer 2, the measurement apparatus 1 is controlled, and the measurement of the electric signal of MSS cartridge 4 is started. Specifically, the voltage application unit 12 of the measurement apparatus 1 applies a voltage to the electrode 43a, 44a of the MSS cartridge 4, and the measurement unit 13 acquires the electric signal of the MSS 43, 44 of the MSS cartridge 4 via the electrode 43a, 44a. Thus, the measurement apparatus 1 acquires the first measurement data Sₙ and the second measurement data sₙ. The first measurement data Sₙ and the second measurement data sₙ are, for example, data in which a measurement time is associated with a measurement value of an electric signal at each time. The measurement time by the measurement apparatus 1 may be a time specified by the user, or may be a time in which the change amount in the electric signal over time becomes equal to or less than a certain value and a period satisfying a certain value becomes a certain period. Then, the measurement apparatus 1 associates the measurement data with the information of the MSS that has measured the data. The identification information acquisition unit 14 of the measurement apparatus 1 acquires the identification information of the MSS cartridge 4 stored in the identifier 42 of the MSS cartridge 4 before and after or at the same time the electric signal is acquired.

Next, the processing by the analyzer 2 is resumed. First, the measurement signal acquisition unit 23 acquires measurement signal data (S4). Specifically, the measurement signal acquisition unit 23 acquires the measurement signal information acquired by the measurement apparatus 1 via the communication cable 3. The measurement signal acquisition unit 23 may acquire the measurement signal information from the measurement apparatus 1 in parallel with the acquisition of the measurement signal information by the measurement apparatus 1. That is, the measurement signal acquisition unit 23 may acquire the measurement signal information from the measurement apparatus 1 over time, or collectively acquire the measurement signal information after acquiring the measurement signal information of the measurement apparatus 1. The measurement signal acquisition unit 23 may acquire the measurement date and time of the measurement signal information together with the measurement signal information.

As described above, the MSS cartridge 4 includes the MSS 43 in which the binding molecule is disposed and the MSS 44 in which the binding molecule is not disposed. Therefore, as shown in FIG. 5, the measurement signal information acquired by the measurement signal acquisition unit 23 includes the first measurement data Sₙ acquired by the MSS 43 and the second measurement data sₙ of the MSS 44 that is a control MSS.

Next, the second identification information acquisition unit 24 acquires identification information of the MSS cartridge 4 that has acquired the measurement signal information (S5). Specifically, the second identification information acquisition unit 24 acquires the identification information of the MSS cartridge 4 acquired by the measurement apparatus 1 via the communication cable 3.

While step S5 is performed after step S4 in the present example embodiment, the order of step S4 and step S5 is not particularly limited, and step S5 may be performed before or after step S4, or step S4 and step S5 may be performed in parallel.

Next, the second association unit 25 associates the measurement signal information with the identification information of the MSS cartridge 4 (S6). Specifically, as shown in FIG. 5, the second association unit 25 associates the first measurement data Sₙ and the second measurement data sₙ with the identification information (nnnn) of the MSS cartridge 4. In the present example embodiment, the second association unit 25 further associates the measurement data information with the reference signal information and the identification information associated with each other by the first association unit 22. That is, the second association unit 25 extracts the corresponding set of the reference signal information and the identification information based on the identification information acquired by the second identification information acquisition unit 24, and associates the measurement signal information with the extracted set of the reference signal information and the identification information. However, the present example embodiment is not limited thereto, and the second association unit 25 may associate the measurement signal information with the identification information separately from the reference signal information and the identification information. As shown in FIG. 5, the second association unit 25 may associate the measurement date and time of the measurement signal information with the identification information (nnnn) of the MSS cartridge 4. Further, the second association unit 25 may check whether or not the identification information of the MSS cartridge 4 corresponding to the identification information of the MSS cartridge 4 acquired by the second identification information acquisition unit 24 is stored prior to associating the measurement signal information with the identification information of the MSS cartridge 4. In this case, when the identification information of the MSS cartridge 4 corresponding to the identification information of the MSS cartridge 4 acquired by the second identification information acquisition unit 24 is stored, the measurement signal information is associated with the stored identification information. On the other hand, when the identification information of the MSS cartridge 4 acquired by the second identification information acquisition unit 24 and the identification information of the corresponding MSS cartridge 4 are not stored, the measurement signal information and the identification information of the MSS cartridge 4 are associated with each other. The second association unit 25 stores, for example, information associated with the storage device 204.

While the association with the subject information such as the subject ID is performed by the first association unit 22 in the present example embodiment, the association may be performed by the second association unit 25. This allows to prepare in advance the MSS cartridge 4 that has measured the reference data using the reference solution. In this case, the analysis system 100 of the present example embodiment can analyze the target in the sample solution by, for example, loading and measuring the sample solution of the subject, and thus can shorten the time from the reception of the sample solution of the subject to the analysis.

Next, the analysis unit 26 analyzes a target in a sample solution from the reference signal information and the measurement signal information associated with the identification information (S7). Specifically, the analysis unit 26 acquires the reference signal information and the measurement signal information associated with the identification information (nnnn) from the storage device 204. When the target is present in the sample solution, the change amount, i.e., the difference between the first reference data and the first measurement data is larger than the change amount between the second reference data and the second measurement data. On the other hand, when no target is present in a sample solution, the change amount, i.e., the difference between the first reference data and the first measurement data is substantially the same as the change amount between the second reference data and the second measurement data, that is, small change amount difference or no substantial difference is observed. Therefore, the analysis unit 26 analyzes a target in a sample solution from, for example, the change amount between the second reference data and the second measurement data and the change amount between the first reference data and the first measurement data.

As a specific example, the analysis unit 26 calculates a change amount (first change amount) between the first reference data and the first measurement data. Next, the analysis unit 26 calculates a change amount (second change amount) between the second reference data and the second measurement data. The change amount is preferably calculated over time according to the measurement time. Then, the analysis unit 26 determines whether the difference between the first change amount and the second change amount satisfies a certain value. When the difference between the first change amount and the second change amount satisfies a certain value, the analysis unit 26 analyzes that the sample solution contains the target. On the other hand, if the difference between the first change amount and the second change amount does not satisfy a certain value, the analysis unit 26 analyzes that the sample solution does not contain the target. The analysis unit 26 may analyze the sample solution based on a period during which the difference in the change amount is maintained in addition to the difference in the change amount. In this case, when the difference in the change amount satisfies a certain value, the analysis unit 26 determines whether the period satisfying the certain value satisfies a certain period of time. When the period satisfying the certain value satisfies the certain period of time, the analysis unit 26 analyzes that the sample solution contains the target. When the period satisfying the certain value does not satisfy the certain period of time, the analysis unit 26 analyzes that the sample solution does not include the target. The certain value and the certain period of time can be set, for example, by preparing a solution containing the target and measuring using the MSS cartridge 4.

While the analysis unit 26 determines whether the difference in the change amount satisfies a certain value, the analysis unit 26 may determine whether the difference in the change amount or the absolute value thereof is larger than a certain value. In this case, the analysis unit 26 determines whether the difference in the change amount or the absolute value thereof is larger than a certain value. When the difference in the change amount or the absolute value thereof is larger than a certain value, the analysis unit 26 analyzes that the sample solution contains the target. On the other hand, when the difference in the change amount or the absolute value thereof is equal to or less than a certain value, the analysis unit 26 analyzes that the sample solution does not contain the target. The analysis unit 26 may analyze the sample solution based on a period during which the difference in the change amount or the absolute value thereof is maintained, in addition to the difference in the change amount or the absolute value thereof. In this case, when the difference in the change amount or the absolute value thereof is larger than a certain value, the analysis unit 26 determines whether a period satisfying the certain value satisfies a certain period of time with respect to the difference in the change amount or the absolute value thereof. When the period larger than the certain value satisfies the certain period of time, the analysis unit 26 analyzes that the sample solution contains the target. When the period larger than the certain value does not satisfy the certain period of time, the analysis unit 26 analyzes that the sample solution does not contain the target. The certain value and the certain period of time can be set by, for example, preparing a solution including the target and measuring using the MSS cartridge 4.

Then, for example, the analysis unit 26 displays the obtained analysis result on the analysis result 206b of the touch panel 206 as positive (presence of target), negative (absence of target), test-required (target unknown), and the like. Further, for example, as shown in FIG. 5, the analysis unit 26 stores the obtained analysis result in the storage device 204 in association with the identification information associated with the reference signal information and the measurement signal information used in the analysis.

While steps S4 to S6 are performed after steps S1 to S3 in the present example embodiment, the analyzer 2 of the present example embodiment may perform steps S1 to S3 after steps S4 to S6.

As shown in FIG. 4, in addition to steps S1 to S7, the analyzer 2 acquires the processing status of the analysis system 100 over time and displays the acquired processing status on the sample solution analysis status 206a of the touch panel 206. Therefore, the analyzer 2 performs the processing of steps S8 to S9 in parallel with the processing of steps S1 to S7.

Specifically, the processing status acquisition unit 27 acquires the processing status of the measurement apparatus 1 and the analyzer 2 of the analyzing system 100 (S8). Specifically, the processing status acquisition unit 27 acquires information on the start of processing by the measurement apparatus 1, the lapse time after the start of processing; the acquisition status of data by the analyzer 2, the analysis status of data, the elapsed time after the start of analysis of data; and the like. Then, the processing status acquisition unit 27 displays the acquired processing status on the analyzing status 206a of the sample solution on the touch panel 206 (S9).

Then, the analyzer 2 of the present example embodiment ends the processing.

According to the analysis system 100 of the present example embodiment, the reference signal information and the measurement signal information, which are information obtained by the MSS cartridge 4, are associated with the identification information of the cartridge 4. Therefore, according to the analysis system 100 of the present example embodiment, even if the MSS cartridge 4 is attached to an analyzer different from the analyzer 2 that has measured the reference signal or to a different attachment portion 11 of the analyzer 2 to measure the measurement signal, generation of erroneous analysis result can be suppressed.

While the analysis system 100 of the present example embodiment includes the measurement apparatus 1 and the analyzer 2, the measurement apparatus 1 is optional and the analysis system 100 may or may not include the measurement apparatus 1. Further, while the measurement apparatus 1 and the analyzer 2 are configured independently in the present example embodiment, they may be integrated. That is, the analyzer 2 may include components of the measurement apparatus 1, and the analyzer 2 may be configured to be capable of performing measurement and analysis.

Further, while the analyzer 2 includes the processing status acquisition unit 27, the processing status acquisition unit 27 is optional and the analyzer 2 may or may not include the processing status acquisition unit 27.

In the analysis system 100 of the present example embodiment, the analyzer 2 may be configured to be able to output an analysis result based on, for example, subject ID information. By configuring the analyzer 2 in this manner, for example, the subject can check the analysis result via a communication line network outside the analysis system 100.

### Second Example Embodiment

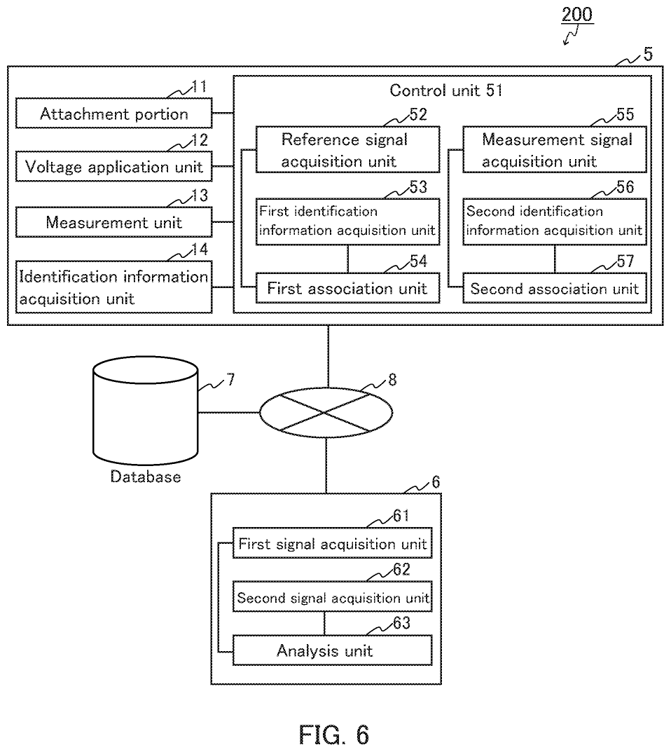

The present example embodiment is an example of a second analysis system including the second analyzer of the invention. FIG. 6 is a schematic diagram illustrating an example of the second analysis system 200 according to the present example embodiment. As shown in FIG. 6, the second analysis system 200 includes a measurement apparatus 5, an analyzer 6, and a data server 7. The measurement apparatus 5 includes an attachment portion 11, a voltage application unit 12, a measurement unit 13, an identification information acquisition unit 14, and a control unit 51. The control unit 51 includes a reference signal acquisition unit 52, a first identification information acquisition unit 53, a first association unit 54, a measurement signal acquisition unit 55, a second identification information acquisition unit 56, and a second association unit 57. The analyzer 6 includes a first signal acquisition unit 61, a second signal acquisition unit 62, and an analysis unit 63. As shown in FIG. 6, the measurement apparatus 5, the analyzer 6, and the data server 7 can be connected to each other via a communication network 8 outside the analysis system 200. The analyzer 6 of the present example embodiment may be incorporated in a server as a system. Further, the analyzer 6 of the present example embodiment may be a personal computer (PC) in which the program of an example aspect of the invention is installed.

The communication network 8 is not particularly limited, and a known network can be used, and may be, for example, a wired network or a wireless network. Examples of the communication network 8 include an internet line, a world wide web (WWW), a telephone line, a local area network (LAN), and a Wireless Fidelity (WiFi).

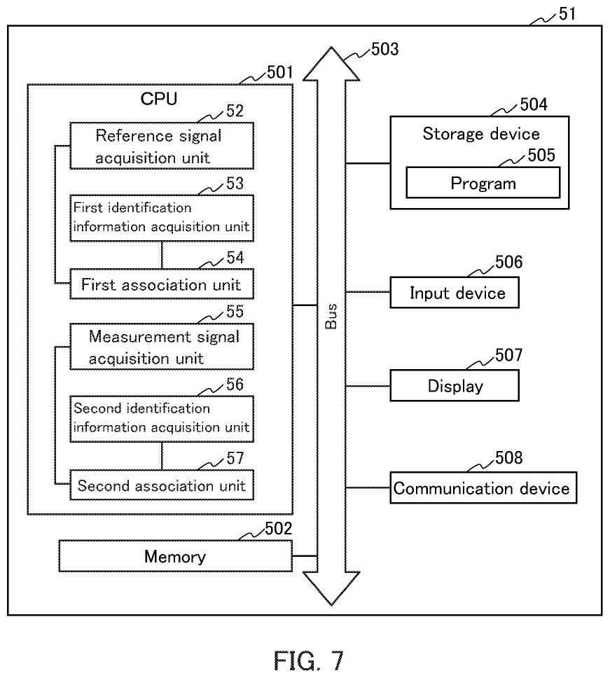

FIG. 7 is a block diagram illustrating a hardware configuration of the control unit 51 of the measurement apparatus 5. Regarding the configuration other than the control unit 51 of the measurement apparatus 5, reference can be made to the description as to the measurement apparatus 1 of the first example embodiment. The control unit 51 of the measurement apparatus 5 includes, for example, a central processor (CPU) 501, a memory 502, a bus 503, a storage device 504, an input device 506, a display 507, a communication device 508, and the like. The components of the control unit 51 of the measurement apparatus 5 are connected via a bus 503 by respective interfaces (I/F).

Regarding each configuration of the control unit 51, reference can be made to the description as to the hardware configuration of the analyzer 2 of the first example embodiment. The control unit 51 is connected to the attachment portion 11, the voltage application unit 12, the measurement unit 13, and the identification information acquisition unit 14 via the communication device 508. The measurement apparatus 5 is connected to the communication line network 8 via the communication device 508.

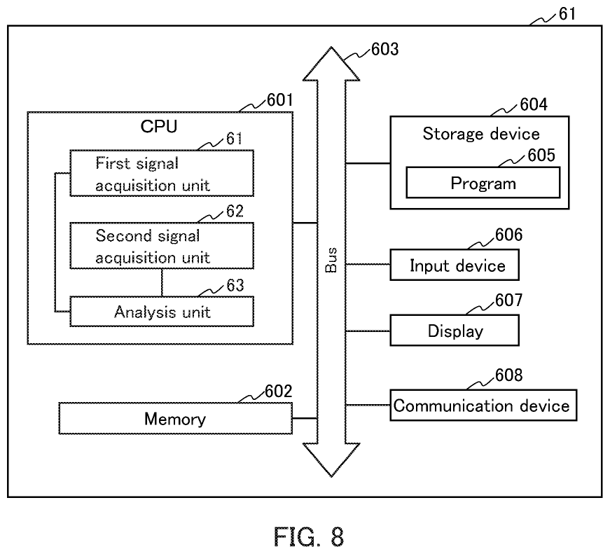

FIG. 8 is a block diagram of a hardware configuration of the analyzer 6. The analyzer 6 includes, for example, a central processor (CPU) 601, a memory 602, a bus 603, a storage device 604, an input device 606, a display 607, a communication device 608, and the like. Regarding each configuration of the analyzer 6, reference can be made to the description as to the hardware configuration of the analyzer 2 of the first example embodiment. The analyzer 6 is connected to the communication line network 8 via the communication device 608.

In the present example embodiment, the data server 7 is a database server in which various kinds of information obtained from the measurement apparatus 5 are stored, as will be described below. The number of various kinds of information stored in the data server 7 is not particularly limited.

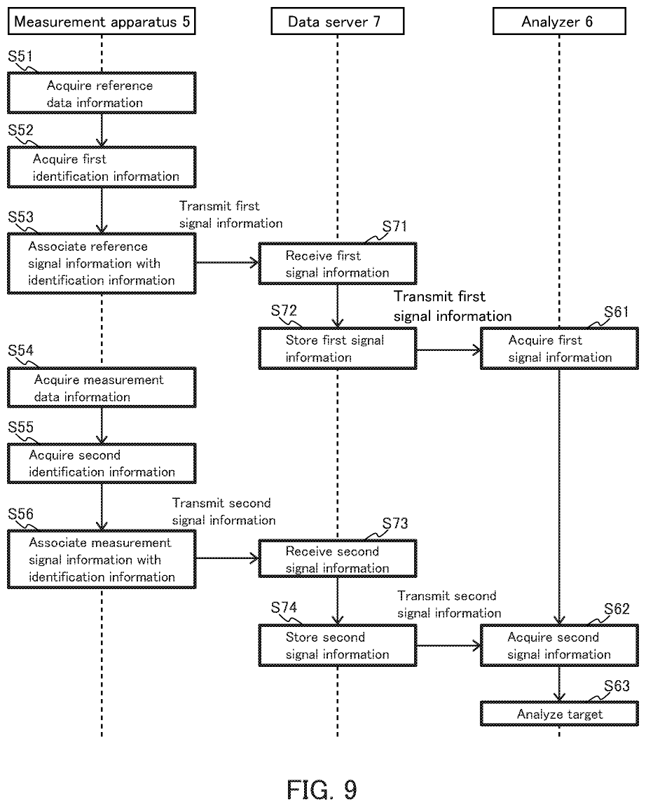

Next, an example of target analysis processing using the measurement apparatus 5, the analyzer 6, and the data server 7 according to the present example embodiment will be described with reference to the flowchart of FIG. 9. While the case where the sample solution derived from the n-th subject is used will be described as an example, the processing can be performed in the same manner also in the case of using the sample solution of another subject and another sample solution.

First, the user of the analyzer 200 loads the reference solution for the n-th subject into the MSS cartridge 4 in the same manner as in the first example embodiment. Then, the user attaches the MSS cartridge 4 to the attachment portion 11 of the measurement apparatus 5. Next, the user instructs the start of measurement and analysis by the measurement apparatus 5 and the analyzer 6.

Next, the reference signal acquisition unit 51, the first identification information acquisition unit 52, and the first association unit 53 acquire the reference signal information, acquire the identification information of the MSS cartridge 4, and associate the reference signal information with the identification information of the MSS cartridge 4 in the same manner as the reference signal acquisition unit 20, the first identification information acquisition unit 21, and the first association unit 22 in the analyzer 2 of the first example embodiment (S51 to S53). Then, the measurement apparatus 5 transmits first signal information, which is information obtained by associating the reference signal information with the identification information of the MSS cartridge 4, to the data server 7 via the communication line network 8.

The data server 7 receives the first signal information from the measurement apparatus 5 (S71) and stores the received first signal information (S72). When the analyzer 6 requests the first signal information, the data server 7 transmits the requested information.

Next, the first signal acquisition unit 61 of the analyzer 6 acquires the first signal data (S61). Specifically, the first signal acquisition unit 61 requests the data server 7 for the first signal information related to the n-th subject. Then, the first signal acquisition unit 61 acquires the first signal information by receiving the first signal information transmitted from the data server 7.

Next, in order to perform measurement using the sample solution of the subject, the user detaches the MSS cartridge 4 from the attachment portion 11 of the measurement apparatus 5. Then, the user removes the reference solution and loads the sample solution of the n-th subject into the MSS 43, 44 of the MSS cartridge 4. Next, the user attaches the MSS cartridge 4 loaded with the sample solution to the attachment portion 11 of the measurement apparatus 5. Then, the user instructs the start of measurement and analysis by the measurement apparatus 5 and the analyzer 6.

Next, the measurement signal acquisition unit 54, the second identification information acquisition unit 55, and the second association unit 56 acquire the measurement signal information, acquire the identification information of the MSS cartridge 4, and associate the measurement signal information with the identification information of the MSS cartridge 4 in the same manner as the measurement signal acquisition unit 23, the second identification information acquisition unit 24, and the second association unit 25 of the analyzer 2 of the first example embodiment (S54 to S56). Then, the measurement apparatus 5 transmits second signal information, which is information obtained by associating the measurement signal information with the identification information of the MSS cartridge 4, to the data server 7 via the communication network 8.

The data server 7 receives the second signal information from the measurement apparatus 5 (S73) and stores the received second signal information (S74). When the analyzer 6 requests the second signal information, the data server 7 transmits the requested information.

Next, the second signal acquisition unit 62 of the analyzer 6 acquires the second signal data (S62). Specifically, the second signal acquisition unit 62 requests the data server 7 for the second signal information related to the n-th subject. Then, the second signal acquisition unit 62 acquires the second signal information by receiving the second signal information transmitted from the data server 7.

Next, the analysis unit 63 analyzes a target in the sample solution from the first signal information and the second signal information (S63). Regarding the analysis by the analysis unit 63, reference can be made to the description as to the analysis unit 26 of the analyzer 2 of the first example embodiment.

According to the analysis system 200 of the present example embodiment, the reference signal information and the measurement signal information, which are information obtained by the MSS cartridge 4, are associated with the identification information of the cartridge 4. Therefore, according to the analysis system 200 of the present example embodiment, even if the MSS cartridge 4 is attached to an analyzer different from the measurement apparatus 5 that has measured the reference signal or to a different attachment portion 11 of the measurement apparatus 5 to measure the measurement signal, generation of erroneous analysis result can be suppressed.

### Third Example Embodiment

A program of the present example embodiment is a program for causing a computer to execute each step (procedure) of the first analysis method or the second analysis method described above. The step may be referred to as, for example, a procedure, processing, an order, a command, or the like. The program of the present example embodiment can also be referred to as, for example, a program for causing a computer to function as the first analyzer or second analyzer. The program of the present example embodiment may be recorded in a computer-readable recording medium, for example. The recording medium is, for example, a non-transitory computer-readable storage medium. The recording medium is not particularly limited, and examples thereof include a random access memory (RAM), a read only memory (ROM), a hard disk (HD), an optical disk, and a floppy disk (FD).

While the invention has been particularly shown and described with reference to example embodiments thereof, the invention is not limited to these embodiments. It will be understood by those of ordinary skill in the art that various changes in form and details may be made therein without departing from the spirit and scope of the invention as defined by the claims.

### Supplementary Note

The whole or part of the example embodiments disclosed above can be described as, but not limited to, the following supplementary notes.

### Supplementary Note 1

A target analyzer, including:
a reference signal acquisition unit;
a first identification information acquisition unit;
a first association unit;
a measurement signal acquisition unit;
a second identification information acquisition unit;
a second association unit; and
an analysis unit, wherein
the reference signal acquisition unit acquires reference signal information, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
the first identification information acquisition unit acquires identification information of the membrane-type surface stress-sensor device that has measured the reference signal information,
the first association unit associates the reference signal information measured using the membrane-type surface stress-sensor device with the identification information of the membrane-type surface stress-sensor device,
the measurement signal acquisition unit acquires measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
the second identification information acquisition unit acquires identification information of the membrane-type surface stress-sensor device that has measured the measurement signal information,
the second association unit associates the measurement signal information with the identification information, and
the analysis unit analyzes a target in the sample solution from the reference signal information and the measurement signal information associated with the identification information.

### Supplementary Note 2

The target analyzer according to Supplementary Note 1, wherein
the analysis unit analyzes a target in the sample solution from a change amount between the first reference data and the first measurement data associated with the identification number and a change amount between the second reference data and the second measurement data associated with the identification number.

### Supplementary Note 3

The target analyzer according to Supplementary Note 1 or 2, wherein
when a difference between the change amount between the first reference data and the first measurement data associated with the identification number and the change amount between the second reference data and the second measurement data associated with the identification number is larger than a certain value, the analysis unit analyzes that the target is present in the sample solution.

### Supplementary Note 4

The target analyzer according to any one of Supplementary Notes 1 to 3, including:
a processing status acquisition unit; and
a display unit, wherein
the processing status acquisition unit acquires a processing status of the target analyzer, and
the display unit displays the processing status.

### Supplementary Note 5

The target analyzer according to any one of Supplementary Notes 1 to 4, including:
a display unit, wherein
the display unit displays an obtained analysis result.

### Supplementary Note 6

The target analyzer according to any one of Supplementary Notes 1 to 5, including:
an attachment portion;
an identification information acquisition unit;
a voltage application unit; and
a measurement unit, wherein
the membrane-type surface stress-sensor device can be detachably attached to the attachment portion,
the identification information acquisition unit is capable of acquiring identification information of the membrane-type surface stress-sensor device,
the voltage application unit can apply a voltage to the membrane-type surface stress-sensor device, and
the measurement unit is capable of measuring a voltage of the membrane-type surface stress-sensor device.

### Supplementary Note 7

A target analyzer, including:
a first signal acquisition unit;
a second signal acquisition unit; and
an analysis unit, wherein
the first signal acquisition unit acquires reference signal information associated with identification information of a membrane-type surface stress-sensor device,
the reference signal information includes at least two reference data measured using the membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
the second signal acquisition unit acquires measurement signal information associated with identification information of the membrane-type surface stress-sensor device, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor, and
the analysis unit analyzes a target in the sample solution from the reference signal information and the measurement signal information associated with the identification information.

### Supplementary Note 8

The target analyzer according to Supplementary Note 7, wherein
the analysis unit analyzes a target in the sample solution from a change amount between the first reference data and the first measurement data associated with the identification number and a change amount between the second reference data and the second measurement data associated with the identification number.

### Supplementary Note 9

The target analyzer according to Supplementary Note 7 or 8, wherein
when a difference between the change amount between the first reference data and the first measurement data associated with the identification number and the change amount between the second reference data and the second measurement data associated with the identification number is larger than a certain value, the analysis unit analyzes that the target is present in the sample solution.

### Supplementary Note 10

The target analyzer according to any one of Supplementary Notes 7 to 9, including:
a processing status acquisition unit; and
a display unit, wherein
the processing status acquisition unit acquires a processing status of the target analyzer, and
the display unit displays the processing status.

### Supplementary Note 11

The target analyzer according to any one of Supplementary Notes 7 to 10, including:
a display unit, wherein
the display unit displays an obtained analysis result.

### Supplementary Note 12

A target analysis method, including:
reference signal acquiring;
first identification information acquiring;
first associating;
measurement signal acquiring;
second identification information acquiring;
second associating; and
analyzing, wherein
in the reference signal acquiring, reference signal information is acquired, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the first identification information acquiring, identification information of the membrane-type surface stress-sensor device that has measured the reference signal information is acquired,
in the first associating, the reference signal information measured using the membrane-type surface stress-sensor device is associated with the identification information of the membrane-type surface stress-sensor device,
in the measurement signal acquiring, measurement signal information is acquired, wherein
the measurement signal information includes at least two measurement data measured using the membrane-type surface stress-sensor device and a sample solution, and
the at least two measurement data include: first measurement data measured using a membrane-type surface stress-sensor in which a binding substance capable of binding to a target is disposed; and second measurement data measured using a control membrane-type surface stress-sensor;
in the second identification information acquiring, identification information of the membrane-type surface stress-sensor device that has measured the measurement signal information is acquired,
in the second associating, the measurement signal information is associated with the identification information, and
in the analyzing, a target in the sample solution is analyzed from the reference signal information and the measurement signal information associated with the identification information.

### Supplementary Note 13

The target analysis method according to Supplementary Note 12, wherein
in the analyzing, a target in the sample solution is analyzed from a change amount between the first reference data and the first measurement data associated with the identification number and a change amount between the second reference data and the second measurement data associated with the identification number.

### Supplementary Note 14

The target analysis method according to Supplementary Note 12 or 13, wherein
in the analyzing, when a difference between the change amount between the first reference data and the first measurement data associated with the identification number and the change amount between the second reference data and the second measurement data associated with the identification number is larger than a certain value, it is analyzed that the target is present in the sample solution.

### Supplementary Note 15

The target analysis method according to any one of Supplementary Notes 12 to 14, including
processing status acquiring; and
displaying, wherein
in the processing status acquiring, a processing status of the target analysis method is acquired, and
in the displaying, the processing status is displayed.

### Supplementary Note 16

The target analysis method according to any one of Supplementary Notes 12 to 15, including:
displaying, wherein
in the displaying, an obtained analysis result is displayed.

### Supplementary Note 17

A target analysis method, including:
first signal acquiring;
second signal acquiring; and
analyzing, wherein
in the first signal acquiring, reference signal information associated with identification information of a membrane-type surface stress-sensor device is acquired,
the reference signal information includes at least two reference data measured using the membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the second signal acquiring, measurement signal information associated with identification information of the membrane-type surface stress-sensor device is acquired, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor, and
in the analyzing, a target in the sample solution is analyzed from the reference signal information and the measurement signal information associated with the identification information.

### Supplementary Note 18

The target analysis method according to Supplementary Note 17, wherein
in the analyzing, a target in the sample solution is analyzed from a change amount between the first reference data and the first measurement data associated with the identification number and a change amount between the second reference data and the second measurement data associated with the identification number.

### Supplementary Note 19

The target analysis method according to Supplementary Note 17 or 18, wherein
in the analyzing, when a difference between the change amount between the first reference data and the first measurement data associated with the identification number and the change amount between the second reference data and the second measurement data associated with the identification number is larger than a certain value, it is analyzed that the target is present in the sample solution.

### Supplementary Note 20

The target analysis method according to any one of Supplementary Notes 17 to 19, including:
processing status acquiring; and
displaying, wherein
in the processing status acquiring, a processing status of the target analysis method is acquired, and
in the displaying, the processing status is displayed.

### Supplementary Note 21

The target analysis method according to any one of Supplementary Notes 17 to 20, including:
displaying, wherein
in the displaying, an obtained analysis result is displayed.

### Supplementary Note 22

A program for causing a computer to execute:
a reference signal acquisition procedure;
a first identification information acquisition procedure;
a first association procedure;
a measurement signal acquisition procedure;
a second identification information acquisition procedure;
a second association procedure; and
an analysis procedure, wherein
in the reference signal acquisition procedure, reference signal information is acquired, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the first identification information acquisition procedure, identification information of the membrane-type surface stress-sensor device that has measured the reference signal information is acquired,
in the first association procedure, the reference signal information measured using the membrane-type surface stress-sensor device is associated with the identification information of the membrane-type surface stress-sensor device,
in the measurement signal acquisition procedure, measurement signal information is acquired, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
in the second identification information acquisition procedure, identification information of the membrane-type surface stress-sensor device that has measured the measurement signal information is acquired,
in the second association procedure, the measurement signal information is associated with the identification information, and
in the analysis procedure, a target in the sample solution is analyzed from the reference signal information and the measurement signal information associated with the identification information.

### Supplementary Note 23

The program according to Supplementary Note 22, wherein
in the analysis procedure, a target in the sample solution is analyzed from a change amount between the first reference data and the first measurement data associated with the identification number and a change amount between the second reference data and the second measurement data associated with the identification number.

### Supplementary Note 24

The program according to Supplementary Note 22 or 23, wherein
in the analysis procedure, when a difference between the change amount between the first reference data and the first measurement data associated with the identification number and the change amount between the second reference data and the second measurement data associated with the identification number is larger than a certain value, it is analyzed that the target is present in the sample solution.

### Supplementary Note 25

The program according to any one of Supplementary Notes 22 to 24, including:
a processing status acquisition procedure; and
a display procedure, wherein
in the processing status acquisition procedure, a processing status of the target analysis method is acquired, and
in the display procedure, the processing status is displayed.

### Supplementary Note 26

The program according to any one of Supplementary Notes 22 to 25, including:
a display procedure, wherein
in the display procedure, an obtained analysis result is displayed.

### Supplementary Note 27

A program for causing a computer to execute:
a first signal acquisition procedure;
a second signal acquisition procedure; and
an analysis procedure, wherein
in the first signal acquisition procedure, reference signal information associated with identification information of a membrane-type surface stress-sensor device is acquired,
the reference signal information includes at least two reference data measured using the membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
in the second signal acquisition procedure, measurement signal information associated with identification information of the membrane-type surface stress-sensor device is acquired, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor, and
in the analysis procedure, a target in the sample solution is analyzed from the reference signal information and the measurement signal information associated with the identification information.

### Supplementary Note 28

The program according to Supplementary Note 27, wherein
in the analysis procedure, a target in the sample solution is analyzed from a change amount between the first reference data and the first measurement data associated with the identification number and a change amount between the second reference data and the second measurement data associated with the identification number.

### Supplementary Note 29

The program according to Supplementary Note 27 or 28, wherein
in the analysis procedure, when a difference between the change amount between the first reference data and the first measurement data associated with the identification number and the change amount between the second reference data and the second measurement data associated with the identification number is larger than a certain value, it is analyzed that the target is present in the sample solution.

### Supplementary Note 30

The program according to any one of Supplementary Notes 27 to 29, including:
a processing status acquisition procedure; and
a display procedure, wherein
in the processing status acquisition procedure, a processing status of the target analysis method is acquired, and
in the display procedure, the processing status is displayed.

### Supplementary Note 31

The program according to any one of Supplementary Notes 27 to 30, including:
a display procedure, wherein
in the display procedure, an obtained analysis result is displayed.

### Supplementary Note 32

A target analysis system, including:
a terminal; and
a server, the terminal and the server being connectable via a communication network outside the system, wherein
the terminal or the server includes:
a reference signal acquisition unit;
a first identification information acquisition unit;
a first association unit;
a measurement signal acquisition unit;
a second identification information acquisition unit;
a second association unit; and
an analysis unit, wherein
the reference signal acquisition unit acquires reference signal information, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
the first identification information acquisition unit acquires identification information of the membrane-type surface stress-sensor device that has measured the reference signal information,
the first association unit associates the reference signal information measured using the membrane-type surface stress-sensor device with the identification information of the membrane-type surface stress-sensor device,
the measurement signal acquisition unit acquires measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
the second identification information acquisition unit acquires identification information of the membrane-type surface stress-sensor device that has measured the measurement signal information,
the second association unit associates the measurement signal information with the identification information, and
the analysis unit analyzes a target in the sample solution from the reference signal information and the measurement signal information associated with the identification information.

### Supplementary Note 33

The target analysis system according to Supplementary Note 32, including:
a first signal acquisition unit; and
a second signal acquisition unit, wherein
the first signal acquisition unit acquires reference signal information associated with identification information of the membrane-type surface stress-sensor device,
the second signal acquisition unit acquires measurement signal information associated with identification information of the membrane-type surface stress-sensor device,
the terminal includes: the reference signal acquisition unit; the first identification information acquisition unit; the first association unit, the measurement signal acquisition unit; and the second identification information acquisition unit, and
the server includes: the first signal acquisition unit, the second signal acquisition unit, and the analysis unit.

### INDUSTRIAL APPLICABILITY

According to an example aspect of the invention, even if the MSS is attached to an analyzer different from the analyzer that has measured the reference signal or to a different attachment portion of the same analyzer to measure the measurement signal, generation of an erroneous analysis result can be suppressed. Thus, the present invention is useful, for example, in the field of sample analysis or testing, medical field, and the like.

What is claimed is:

1. A target analyzer, comprising at least one processor configured to:
acquire reference signal information, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
acquire identification information of the membrane-type surface stress-sensor device that has measured the reference signal information,
associate the reference signal information measured using the membrane-type surface stress-sensor device with the identification information of the membrane-type surface stress-sensor device,
acquire measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
acquire identification information of the membrane-type surface stress-sensor device that has measured the measurement signal information,
associate the measurement signal information with the identification information, and
analyze a target in the sample solution from the reference signal information and the measurement signal information associated with the identification information.

2. The target analyzer according to claim 1, wherein the processor is configured to:
analyze a target in the sample solution from a change amount between the first reference data and the first measurement data associated with the identification information and a change amount between the second reference data and the second measurement data associated with the identification information.

3. The target analyzer according to claim 1, wherein the processor is configured to:
analyze that the target is present in the sample solution, when a difference between the change amount between the first reference data and the first measurement data associated with the identification information and the change amount between the second reference data and the second measurement data associated with the identification information is larger than a certain value.

4. The target analyzer according to claim 1,
wherein the processor is configured to:
acquire a processing status of the target analyzer, and
display the processing status.

5. The target analyzer according to claim 1, wherein the processor is configured to:
display an obtained analysis result.

6. The target analyzer according to claim 1, comprising:
an attachment portion;
a reader;
a power source;
a voltage sensor, wherein
the membrane-type surface stress-sensor device can be detachably attached to the attachment portion,
the reader is capable of acquiring identification information of the membrane-type surface stress-sensor device,
the power source can apply a voltage to the membrane-type surface stress-sensor device, and
the voltage sensor is capable of measuring a voltage of the membrane-type surface stress-sensor device.

7.-11. (canceled)

12. A computer-implemented method for a target analysis, comprising:
acquiring reference signal information, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
acquiring identification information of the membrane-type surface stress-sensor device that has measured the reference signal information,
associating with the reference signal information measured using the membrane-type surface stress-sensor device and the identification information of the membrane-type surface stress-sensor device,
acquiring measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
acquiring identification information of the membrane-type surface stress-sensor device that has measured the measurement signal information is acquired,
associating with the measurement signal information and the identification information, and
analyzing a target in the sample solution from the reference signal information and the measurement signal information associated with the identification information.

13. The method according to claim 12, comprising:
analyzing a target in the sample solution from a change amount between the first reference data and the first measurement data associated with identification information and a change amount between the second reference data and the second measurement data associated with the identification information.

14. The method according to claim 12, comprising:
analyzing that the target is present in the sample solution, when a difference between the change amount between the first reference data and the first measurement data associated with the identification information and the change amount between the second reference data and the second measurement data associated with the identification information is larger than a certain value.

15. The method according to claim 12, comprising:
acquiring a processing status of the target analysis method, and
displaying the processing status.

16. The method according to claim 12, comprising:
displaying an obtained analysis result.

17.-21. (canceled)

22. A non-transitory computer readable recording medium with a program, wherein:
the program cause a computer to execute a method for a target analysis, wherein
the method comprising:
acquiring reference signal information, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
acquiring identification information of the membrane-type surface stress-sensor device that has measured the reference signal information,
associating with the reference signal information measured using the membrane-type surface stress-sensor device and the identification information of the membrane-type surface stress-sensor device,
acquiring measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
acquiring identification information of the membrane-type surface stress-sensor device that has measured the measurement signal information,
associating with procedure, the measurement signal information and the identification information, and
analyzing a target in the sample solution is analyzed from the reference signal information and the measurement signal information associated with the identification information.

23. The recording medium according to claim 22, wherein, the method comprising:
analyzing a target in the sample solution from a change amount between the first reference data and the first measurement data associated with the identification information and a change amount between the second reference data and the second measurement data associated with the identification information.

24. The recording medium according to claim 22, wherein
the method comprising:
analyzing that the target is present in the sample solution, when a difference between the change amount between the first reference data and the first measurement data associated with the identification information and the change amount between the second reference data and the second measurement data associated with the identification information is larger than a certain value.

25. The recording medium according to claim 22, wherein
the method comprising:
acquiring a processing status of the target analysis method, and
displaying the processing status.

26. The recording medium according to claim 22, wherein
the method comprising:
displaying an obtained analysis result.

27.-31. (canceled)

32. A target analysis system comprising the target analyzer according to claim 1, comprising:
a terminal; and
a server, the terminal and the server being connectable via a communication network outside the system, wherein
the terminal or the server comprises at least one processor configured to:
acquire reference signal information, wherein
the reference signal information includes at least two reference data measured using a membrane-type surface stress-sensor device and a reference solution,
the membrane-type surface stress-sensor device includes a membrane-type surface stress-sensor in which a binding substance capable of binding to a target is disposed and a control membrane-type surface stress-sensor, and
the at least two reference data include: first reference data measured using the membrane-type surface stress-sensor in which a binding substance capable of binding to a target is disposed; and second reference data measured using the control membrane-type surface stress-sensor;
acquire identification information of the membrane-type surface stress-sensor device that has measured the reference signal information,
associate the reference signal information measured using the membrane-type surface stress-sensor device with the identification information of the membrane-type surface stress-sensor device,
acquire measurement signal information, wherein
the measurement signal information includes at least two measurement data measured using the membrane-type surface stress-sensor device and a sample solution, and
the at least two measurement data include: first measurement data measured using the membrane-type surface stress-sensor in which a binding substance capable of binding to a target is disposed; and second measurement data measured using the control membrane-type surface stress-sensor;
acquire identification information of the membrane-type surface stress-sensor device that has measured the measurement signal information,
associate the measurement signal information with the identification information, and
analyze a target in the sample solution from the reference signal information and the measurement signal information associated with the identification information.

33. The target analysis system according to claim 32, wherein,
the processor of the terminal is configured to:
acquire the reference signal information,
acquire the identification information of the membrane-type surface stress-sensor device that has measured the reference signal information,
associate the reference signal information measured using the membrane-type surface stress-sensor device with the identification information of the membrane-type surface stress-sensor device,
acquire the measurement signal information, and
acquire the identification information of the membrane-type surface stress-sensor device that has measured the measurement signal information, and,
the processor of the server is configured to:
acquire reference signal information associated with identification information of the membrane-type surface stress-sensor device,
acquire measurement signal information associated with identification information of the membrane-type surface stress-sensor device, and
analyze a target in the sample solution from the reference signal information and the measurement signal information associated with the identification information.
